(19) United States
(12) Patent Application Publication
(10) Pub. No.: US 2004/0011669 A1
(43) Pub. Date: Jan. 22, 2004

(54) Protection of reinforced concrete

(76) Inventors: Gareth K. Glass, Lichfield (GB); Adrian C. Roberts, Chillwell (GB); John M. Taylor, Tamworth (GB)

Correspondence Address: NIXON & VANDERHYE, PC, 1100 N GLEBE ROAD, 8TH FLOOR, ARLINGTON, VA, 22201-4714, US

(21) Appl. No.: 10/460,664

(22) Filed: Jun. 13, 2003

(30) Foreign Application Priority Data
Jun. 14, 2002 (GB) 0213717.2

(51) Int. Cl. B23H 5/10

(52) U.S. Cl. 205/766; 204/288.1; 204/288.3; 204/290.01; 29/522.1

(57) ABSTRACT

An anode assembly for insertion in a gap between a section of reinforced concrete and another solid structure, which may be another section of concrete, comprises an anode attached to a body of deformable material which is preferably resiliently deformable, whereby, when the assembly is inserted into the gap, the anode is pressed into electrical contact with the concrete surface.

Preferably means are provided to expand the body of deformable material to press the anode into contact with the concrete which may comprise

a slot in the body of deformable material and a strip of size greater than the slot for insertion into the slot, the strip preferably being coated with a friction reducing material or

a cavity in the body which cavity can be inflated by the admission of a fluid thereto or

a deformed resilient member under a constraint expandable in the direction of the gap on removal of the constraint or

a hydrophilic member expandable on contact with water.

### FIELD OF THE INVENTION

This invention relates to the protection of reinforced concrete, more particularly to the protection of the steel reinforcement in the region of the joints in the concrete.

### BACKGROUND OF THE INVENTION

To protect the steel reinforcement in reinforced concrete various electrochemical methods have been previously described. Examples of such methods include cathodic protection, chloride extraction, realkalisation and electrochemical impregnation of corrosion inhibitors. Of these methods cathodic protection has been widely used. One form of cathodic protection is galvanic and employs a metal having a more negative electrode potential than steel and which, when connected electrically to the steel, behaves as an anode and causes the steel to behave as a cathode. Such anodes, which may for example be of zinc, will corrode in preference to the steel, and are called sacrificial anodes.

A galvanic arrangement is described in U.S. Pat. Nos. 5,714,045; 6,022,469 and 6,303,017.

Another form of cathodic protection employs an anode made of a more inert electrical conductor, for example activated titanium or carbon, and an external current, sometimes referred to as an impressed current, is applied to make the more inert conductor behave as the anode and the steel behave as the cathode. An example of impressed current cathodic protection is described in U.S. Pat. No. 4,900,410.

In both forms of cathodic protection the anode is usually applied to the concrete surface or embedded in the concrete or covered by the concrete or a mortar in some way.

### PROBLEM TO BE SOLVED BY THE INVENTION

Concrete is usually laid in sections with an expansion gap between adjacent sections. The concrete is often heavily reinforced at the ends of each section De-icing or marine salts may build up in and around the gap and cause corrosion of the steel. Electrochemical protection of steel at these locations is difficult using anode systems currently available. These are normally installed on exposed surfaces or within drilled holes or slots. The ability of anodes installed on exposed surfaces or within slots to deliver current to steel down the face of the deck joint is restricted by the high steel density and resistivity of the concrete. The installation of anode systems in a deck joint is difficult because of both limited access and fluctuation in the width of the gap because the width will vary with temperature.

The present invention provides a solution to this problem by providing an anode assembly that is easy to install in these confined locations and uses agents commonly available to maintain the function of the anode.

### SUMMARY OF THE INVENTION

According to the present invention there is provided an anode assembly for insertion in a gap between a section of reinforced concrete and another solid structure which may be another section of concrete, said assembly comprising an anode attached to a body of deformable material, which is preferably resiliently deformable whereby, when the assembly is inserted into the gap, the anode is pressed into electrical contact with the concrete surface.

### ADVANTAGEOUS EFFECT OF THE INVENTION

The deformable material allows for concrete movement such as by thermal expansion and contraction thus ensuring that the anode is kept proximate to the concrete surface and thereby maintains the ionically conducting electrical connection required for electrochemical treatment such as cathodic protection.

### BRIEF DESCRIPTION OF THE DRAWINGS

FIG. 1 is a cross section showing the anode assembly and a strip for expanding the body of deformable material.

FIG. 2 is a vertical cross section showing the anode assembly located in a joint between sections of concrete.

FIG. 3 is a photograph showing a zinc plate bonded to a concrete surface by means of a latent adhesive.

FIG. 4 is a vertical section of the system used to test an anode assembly.

FIG. 5 is a photograph showing the anode system located between concrete blocks.

FIG. 6 is a graphical representation of galvanic current against time.

FIG. 7 is a photograph showing an opened gap between concrete blocks with a zinc anode bonded to the concrete surface and the deformable material removed.

### DETAILED DESCRIPTION OF THE INVENTION

The gap may be an expansion joint and the solid structure may be another section of reinforced concrete.

The resiliently deformable material is conveniently an elastomeric polymer or foamed polymer such as a polyurethane or polymer of ethylene or propylene or the like.

The body of deformable material may be a tube or other body defining a cavity containing a fluid allowing compression to occur in one dimension whilst expansion takes place in another dimension. The deformable tube or other body defining the cavity may contain a deformable fluid such as air or a foamed polymer.

The body of deformable material may comprise a tube e g of rubber or the like, inflated with a non compressible fluid. The inflated tube will be deformable in one dimension and expand in other dimensions and will thus be able to adjust to the live nature of a concrete deck joint.

The polymer is preferably selected from those which are capable of absorbing water i.e. it is hydrophilic to assist in maintaining a moist condition at the anode.

The size of the assembly will be chosen so that the assembly is suitable for insertion in the gap between the section of concrete and the structure.

In most cases the width of the gap will be at least 8 mm, more often at least 1 cm and will usually be not more than 100 mm.

In many cases the gap will be an expansion joint, alternatively referred to as a live joint, between sections of reinforced concrete. These gaps are typically about 30 mm eg 20 to 40 mm in width. The width varies with the temperature. Sometimes the gap is filled with a sealant but the sealant usually has a limited life. To install the anode of the invention the sealant, if present, will first be removed.

To maintain improved contact between the anode and the concrete the assembly may be expandable, for example by

the body of resiliently deformable material being provided with a slot and, providing a strip of size greater than the slot for insertion into the slot, the strip preferably being coated with a friction reducing material such as polyethylene or polytetrafluoroethylene (Teflon) or

providing a cavity in the body of deformable material and inflating the body by a fluid admitted to the cavity or by means of a foam or elastomeric material such as those described in U.S. Pat. No. 4,683,929 which describes a deflation proof pneumatic tire with elastomeric fillings and U.S. Pat. No. 4,670,995 which describes an air cushion shoe sole or

providing a compressed resilient member expandable on removal of a constraint such as a resilient foamed polymer that is compressed by a removable mechanical clip or a resilient tube such as Tygon™ R-3603 tubing for peristaltic pumps marketed by RS Components Ltd that has been deflated and sealed with a seal that can be punctured, or

providing a hydrophilic member expandable on contact with water such as Supercast SW 20™ marketed by Fosroc International Limited.

When the body is provided with a slot and a strip of material for insertion into the slot, the strip may be provided with a punch suitable to receive a blow from a hammer or mallet to assist in forcing the strip into the slot. The punch may be removably attached to the strip.

The anode in the anode assembly may be a sacrificial anode or an impressed current anode. The anode is preferably attached to the body of deformable material in a manner so that the anode provides an outer surface of the assembly.

The anode may be coated with an ionically conducting medium or located within such a medium so that the medium provides the outer surface of the assembly and which in use will be pressed against the concrete surface.

The anode assembly is preferably coated with an adhesive that forms an ionically conducting bond with the concrete.

The adhesive may be an adhesive that is activated by moisture. The adhesive may be applied directly to the anode when this is located on the outer surface of the assembly. The adhesive may contain agents such as alkaline, hydrophilic or electrolytic materials to maintain the activity of the anode and prolong its life.

The anode may be provided with a non sacrificial conductor to maintain electrical continuity through the anode. When the anode is an impressed current anode such as mixed metal oxide coated titanium, the non sacrificial conductor may be a titanium wire. When the anode is a sacrificial anode, such as zinc, the non sacrificial conductor may be a steel wire.

So that the anode will remain in contact with the concrete surface in the event that the compression is removed or the anode assembly is placed under tension, the anode assembly preferably has one or more relatively weak zones or planes of relative weakness where it will separate leaving the anode in ionic contact with the concrete surface. The planes of weakness may be provided by

including in the assembly sections that are not bonded to each other, said sections preferably being held together by a temporary restraint or

including in the assembly sections that are joined with an adhesive that will decompose in the environment in which the assembly is installed for example a water soluble adhesive or

including in the assembly sections that are joined with a weak adhesive that is relatively easily broken.

According to another aspect of the invention a method for the installation of an anode at a gap between a section of concrete and another structure, which may be another section of concrete, comprises inserting the anode into the gap and pressing the anode into contact with the concrete surface by inserting into the gap a body of deformable material which is preferably resiliently deformable in a manner such that the body of deformable material is retained in the gap and maintains the anode in contact with the concrete surface.

The body of resiliently deformable material is preferably expanded after insertion into the gap.

The expansion may be effected by the body of deformable material being provided with

a slot and to expand the body of deformable material a strip of size greater than the slot is forced into the slot or

an inflatable element and the element is inflated, preferably by the compressible body having a cavity to which a fluid is admitted or

a deformed resilient member under a constraint is inserted into the gap and the constraint removed to allow the member to expand or

a hydrophilic member expandable on contact with water.

According to another aspect of the invention there is provided a method of electrochemically treating reinforced concrete at a gap between a section of the reinforced concrete and another structure which method comprises inserting an anode into the gap and pressing the anode into contact with the concrete surface by inserting a deformable body into the gap where the anode is either a sacrificial anode that is electronically connected to the steel reinforcement or an impressed current anode that is electronically connected to the positive terminal of a direct current power supply and the steel reinforcement is electronically connected to the negative terminal of the direct current power supply.

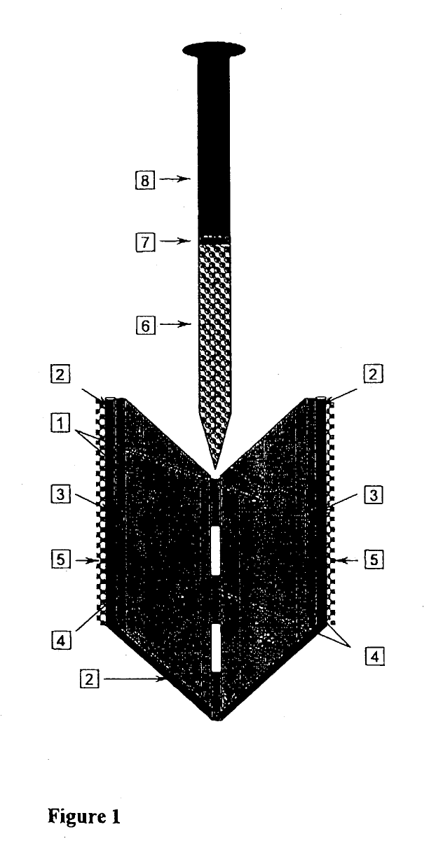

One embodiment of the invention is given in FIG. 1.

In this embodiment, two deformable strips 1 are attached to each other with a temporary adhesive 4. Examples of the compressible strip include polyethylene and polyurethane and these strips may be designed to absorb water thereby maintaining a high moisture content at the anode material 2. An anode material 2, such as a strip of zinc (or zinc alloy), aluminium (or aluminium alloy), carbon (or carbon fibre) or activated titanium is attached to the outer surface of the deformable strips also using a temporary adhesive 4. Both mesh and sheet forms of the anode material may be used. An example of the temporary adhesive is a water soluble glue, a brittle filler material that may be easily broken, or even blue tac. A non-sacrificial electronic conductor 3 may be used to maintain electronic continuity through the anode material 2. This is useful if the anode material is a sacrificial anode. The conductor 3 may also serve as a connection to the anode material. Examples of conductor 3 include wires made of titanium, steel or copper, or carbon fibre. It may be fixed to the anode with a mechanical bond. If a sacrificial anode material 2 such as zinc or aluminium is used then the conductor 3 may be connected directly to the reinforcing steel in the concrete. If it is an impressed current anode it will be connected to a terminal of a power supply. A latent adhesive layer 5 is placed on the outer surface of the anode material. This latent adhesive 5 has the property that it will form a bond with the concrete walls of the joint when it is compressed against them, for example, by reacting with moisture on the concrete surface, and it will contain an electrolyte allowing current to flow through it. An example of a latent adhesive is unhydrated cement suspended in a deliquescent material such as di(ethylene glycol)butyl ether. Another strip 6 is designed to be inserted between the strips 1 to put them into compression. This may be a deformable polymer, a hydrophilic polymer or even an inflatable element. A device 8 may be used to insert the strip 6 to which it is connected with a weak joint 7 which is designed to break when the device 8 is removed. Temporary adhesive 4 provides planes of weakness to allow separation of the strips 1 from the anode 2 in the event that the joint opens and the assembly is placed under tension.

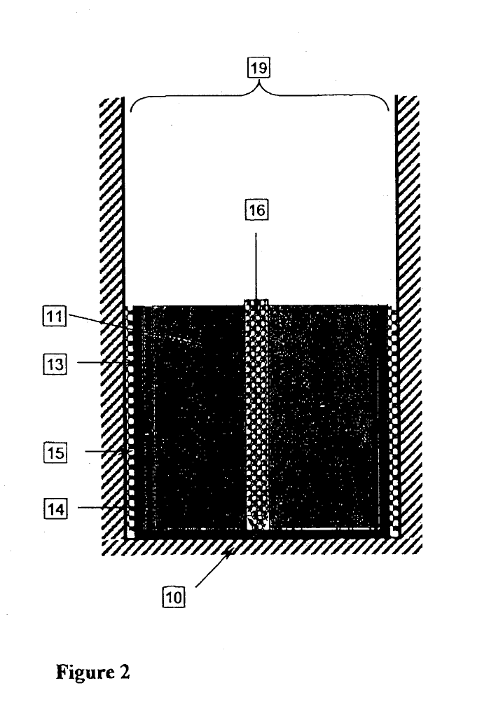

FIG. 2 shows the anode assembly in a concrete joint 19. The direction of the gap is shown horizontally in FIG. 2 ie left to right in the plane of the paper. When the anode is pushed up against a face 10, the polymer strips 11 will expand sideways and go into compression when they meet the walls of the joint. If the joint is open at both ends, a compressible board such as fibre board may be inserted to form the face 10. If further compression is needed because the joint width is irregular or very wide, the strip 16 may be inserted between the strips 11 or one of the compressible strips may be designed to be inflated. If 16 is a hydrophilic strip, it will expand in the 20 presence of water to increase the compression in strips 11. The anode material 13 and latent adhesive 15 is compressed against the concrete walls. The latent adhesive 15 hydrates in the presence of the moisture in the joint to form a bond with the concrete surface. The presence of de-icing salt in the joint will maintain a sacrificial anode material 13 in an active state. The temporary adhesive 14 is weakened by the presence of moisture. If the joint subsequently opens sufficiently to relieve the compressive stress, the strip 11 may separate from the anode 13 leaving the latter in contact with the concrete.

The invention is illustrated by the following Examples.

### EXAMPLE 1

A latent ionically conductive adhesive for bonding zinc to concrete in the presence of moisture was prepared by blending dry ordinary Portland cement powder with a water free diluent, di(ethylene glycol)butyl ether. The blend consisted of 25 g di(ethylene glycol)butyl ether and 100 g OPC powder and was achieved using a high shear mixer (Hauschild DAC150FV SpeedMixer™) for 15 s.

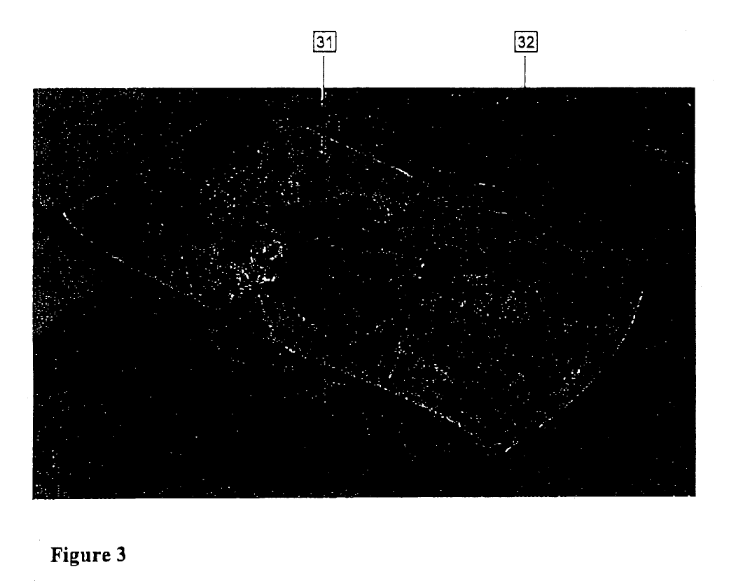

FIG. 3 shows a zinc plate 31 that has been bonded to a concrete substrate 32 using this latent adhesive. One face of a zinc plate 31 was coated with a 1 mm layer of the di(ethylene glycol)butyl ether/OPC blend. The concrete slab 32 was wetted and the coated zinc face was pressed onto the wetted concrete slab. The arrangement was periodically wetted. After 3 weeks, the zinc was removed (the bond strength between the zinc and the latent adhesive is very dependent on the geometry of the zinc). The bond between the adhesive and the concrete slab was tested using a pull-off gauge. A dolly was attached to the latent adhesive using a 2-part epoxy resin. An increasing tensile stress was applied to the latent adhesive until failure occurred. The failure occurred between the concrete and the latent adhesive at a tensile stress of 0.2 N/mm².

### EXAMPLE 2

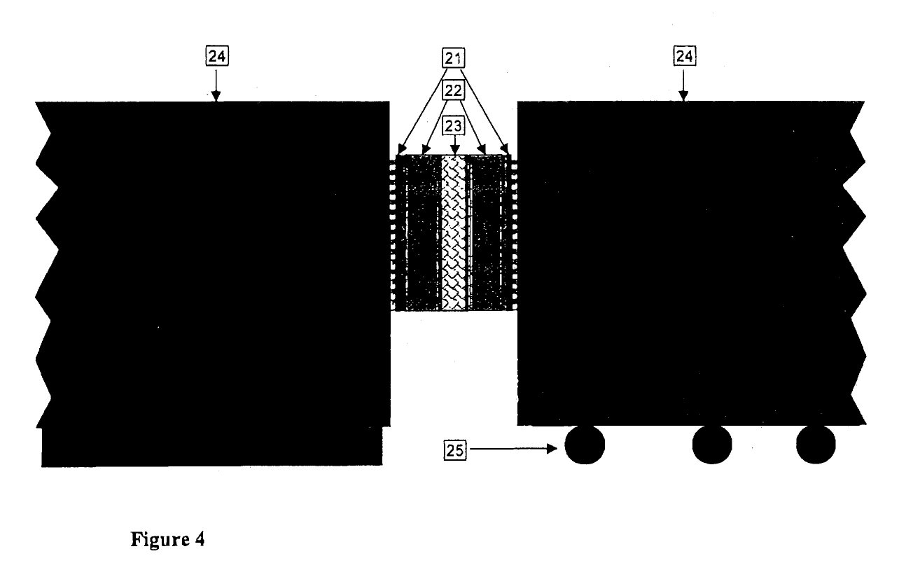

FIG. 4 shows the arrangement used to test a compressible zinc anode. Zinc sheets 21 with a size of approximately 60×140×0.4 mm were bonded to a layer of polyethylene foam 22 using a water-soluble adhesive (wall paper paste). The di(ethylene glycol)butyl ether/ordinary Portland cement powder blend was placed on the surface of the zinc to form a 1 mm thick layer that would hydrated to produce a bond between the zinc and the concrete face of the joint in the presence of water. A polystyrene strip 23 formed the layer that separated 2 zinc/polymer/latent adhesive strips. This could be inserted between two zinc strips to put the polymer into compression and its size could be varied to take account of a variation of joint widths at the time of installation. The polystyrene strip was not bonded to the rest of the assembly.

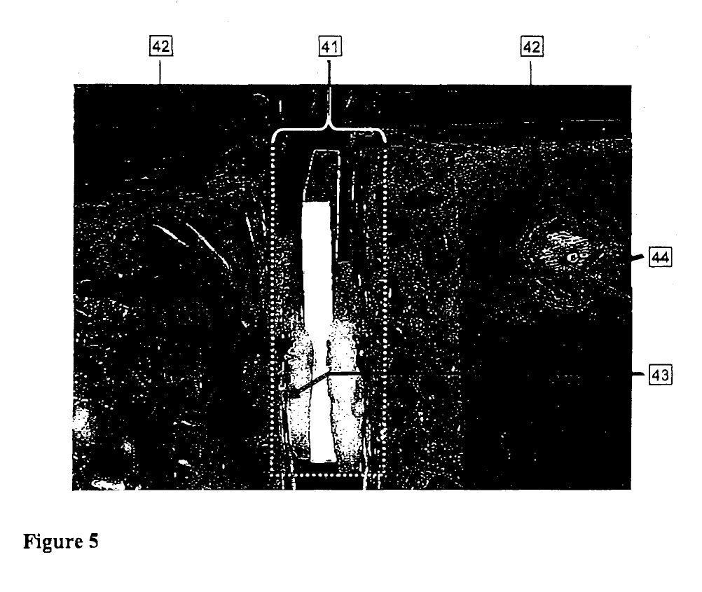

Two reinforced concrete blocks (1000×1000×400 mm) 24 were placed to form a joint with a gap of approximately 50 mm. One of the blocks was placed on rollers 25 to allow the gap to be varied to simulate opening and test the effectiveness of the anode when it is put into tension. After inserting the anode the joint was periodically wetted, with both tap water and salt solution to simulate the action of rain and de-icing salts. A photograph of the arrangement showing the anode system 41, concrete blocks 42 and connections to the anode 43 and reinforcing steel 44 is given in FIG. 5.

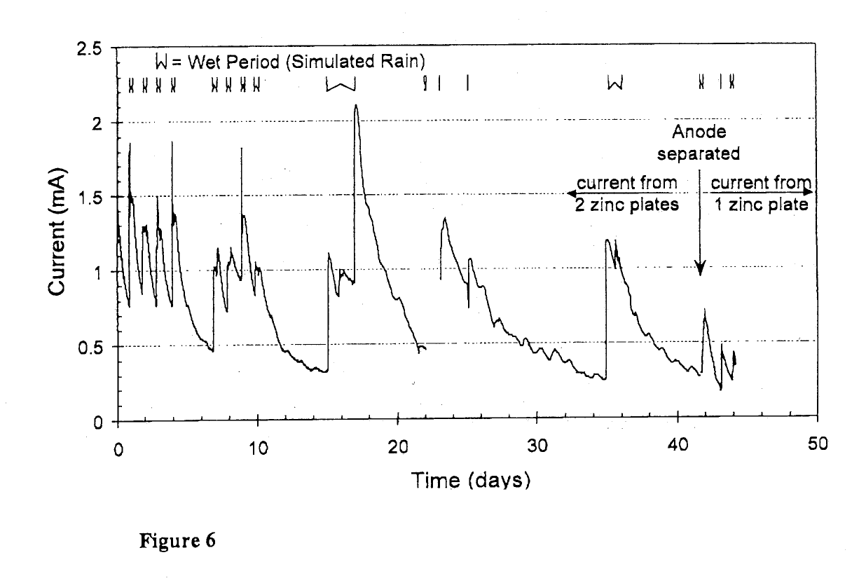

The galvanic current flowing between the zinc sheet and the steel was measured by measuring the voltage across a 100 ohm resistor connecting the zinc to the steel and converting the voltage to a current reading using ohms law. A data logger was used to record the readings. The current time data is given in FIG. 6

Wet periods that might simulate rainfall or the use of de-icing salt are indicated by the symbol W, the width of which indicates the duration of the wet period. The current varies with the presence of moisture and is markedly higher when the anode assembly is wetted either with water or with saturated sodium chloride solution. After 13.5 days a particularly high current output greater than 2 mA resulted from wetting the assembly with saturated sodium chloride solution.

After 42 days the anode assembly was put into tension by opening the gap. The components of the anode assembly were separated and those components that were easily separated were removed. The bond formed by the (diethylene glycol)butyl ether/ordinary Portland cement powder blend that was placed on the surface of the concrete. One zinc plate separated easily from the concrete surface and was removed.

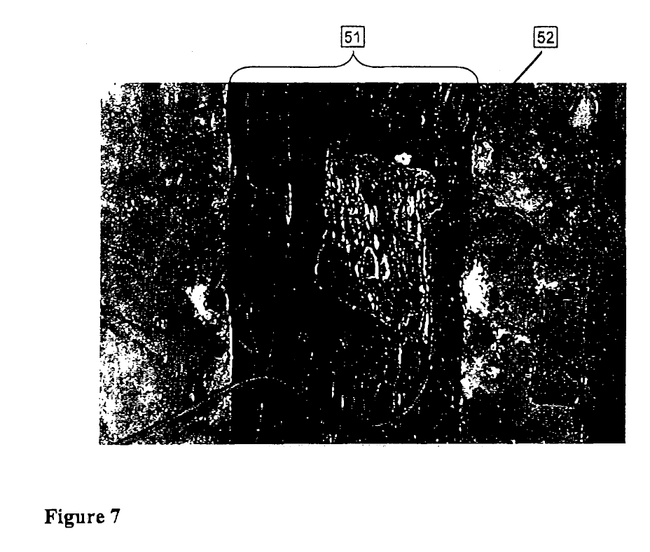

Referring to FIG. 7 this shows the opened gap 51 between the concrete blocks and the zinc plate 52 bonded to the concrete surface within the gap after all the compressible material had been removed. The zinc plate was covered with a patchy white zinc corrosion product. The current output from this zinc plate in included in FIG. 6 as the data obtained after periods longer than 42 days. The current output typically varied between 0.25 and 2 mA prior to the separation of the anode assembly. Less current flowed from the single remaining zinc plate after the anode assembly was separated. When expressed as a current per unit of contact area between the zinc and the concrete surface, the current output equates to approximately 12 to 100 mA/square metre.

1. An anode assembly for insertion in a gap between a section of reinforced concrete and another solid structure said assembly comprising an anode attached to a body of deformable material whereby, when the assembly is inserted into the gap, the anode is pressed into electrical contact with the concrete surface.

2. An anode assembly as claimed in claim 1 wherein the deformable material is resiliently deformable.

3. An anode assembly as claimed in claim 1 or claim 2 wherein means are provided to expand the body of deformable material to press the anode into contact with the concrete.

4. An anode assembly as claimed in claim 3 wherein the means to expand the body of deformable material comprises
a slot in the body of deformable material and a strip of size greater than the slot for insertion into the slot, the strip preferably being coated with a friction reducing material or
a cavity in the body which cavity can be inflated by the admission of a fluid thereto or
a deformed resilient member under a constraint expandable on removal of the constraint preferably in the direction of the gap or
a hydrophilic member expandable on contact with water.

5. An anode assembly as claimed in claim 4 wherein the strip is provided with a punch to assist in forcing the strip into the slot.

6. An assembly as claimed in any one of the preceding claims wherein to enable the anode to remain in contact with the concrete surface in the event that the compression is removed or the anode assembly is placed under tension, the anode assembly has one or more relatively weak zones or planes of weakness where it will separate leaving the anode in ionic contact with the concrete surface.

7. An anode assembly as claimed in claim 6 wherein the planes of weakness are provided by
including in the assembly sections that are not bonded to each other, said sections preferably being held together by a temporary restraint or
including in the assembly sections that are joined with an adhesive that will decompose in the environment in which the assembly is installed for example a water soluble adhesive or
including in the assembly sections that are joined with a weak adhesive that is relatively easily broken.

8. An anode assembly as claimed in any one of the preceding claims wherein the anode is attached to the outer surface of the body of deformable material.

9. An anode assembly as claimed in any one of the preceding claims wherein the anode has a coating of an adhesive to form an ionically conducting bond between the anode and the concrete, the adhesive preferably being an adhesive that is activated by moisture.

10. An anode assembly as claimed in any one of the preceding claims wherein the anode is provided with a non sacrificial conductor such as a wire of titanium, steel or copper to maintain electrical continuity through the anode.

11. An anode assembly as claimed in claim 9 wherein the adhesive contains an agent to enhance the function of the anode.

12. A method for the installation of an anode in a gap between a section of concrete and another structure which method comprises
inserting the anode into the gap and pressing the anode into contact with the concrete surface by also inserting into the gap a body of deformable material, which is preferably resiliently deformable, in a manner such that the body of deformable material is retained in the gap and presses the anode into contact with the concrete surface.

13. A method as claimed in claim 12 wherein the body of resiliently deformable material is expanded after insertion into the gap.

14. A method as claimed in claim 13 wherein the body of deformable material is provided with
a slot and to expand the body of deformable material a strip of size greater than the slot is forced into the slot or
an inflatable element and the element is inflated, preferably by the deformable body having a cavity to which a fluid is admitted or
a deformed resilient member under a constraint is inserted into the gap and the constraint removed to allow the member to expand, preferably in the direction of the gap or
a hydrophilic member expandable on contact with water.

15. A method of electrochemically treating reinforced concrete at a gap between a section of the reinforced concrete and another structure which method comprises inserting an anode into the gap and pressing the anode into contact with the concrete surface by inserting a body of deformable material into the gap where the anode is either a sacrificial anode that is electronically connected to the steel reinforcement or an impressed current anode that is electronically connected to the positive terminal of a direct current power supply and the steel reinforcement is electronically connected to the negative terminal of the direct current power supply.

16. A method as claimed in claim 15 where the deformable body is expanded after insertion into the gap.
